(19) United States
(12) Patent Application Publication
(10) Pub. No.: US 2010/0101664 A1
(43) Pub. Date: Apr. 29, 2010

(54) FLUID CONTROL APPARATUS

(75) Inventors: Takashi Yamamoto, Miyazaki (JP); Kenro Yoshino, Miyazaki (JP)

Correspondence Address: BUCHANAN, INGERSOLL & ROONEY PC, POST OFFICE BOX 1404, ALEXANDRIA, VA, 22313-1404, US

(73) Assignee: Asahi Organic Chemicals Industry Co., Ltd., Nobeoka-shi (JP)

(21) Appl. No.: 12/532,263

(22) PCT Filed: Mar. 28, 2008
(86) PCT No.: PCT/JP2008/056741

§ 371 Date: Sep. 21, 2009

(30) Foreign Application Priority Data
Mar. 30, 2007 (JP) 2007-091280

(51) Int. Cl. F16K 31/00

(52) U.S. Cl. 137/486

(57) ABSTRACT

A fluid control apparatus is provided, in which a tube (14) is passed through a through-hole of a holding unit (30,31), and a first and second coupling units (20,24) fitted with an insert portions at both ends of the tube are fitted on a large-diameter portion of the holding unit, and a flange of the second coupling unit (24) and the holding unit are fixed in pressure contact between a fluid control pipe member and a measuring instrument (2), and a connection unit of the second coupling unit (24) is directly connected to a fluid inlet or a fluid outlet of the measuring instrument (2).

### TECHNICAL FIELD

This invention relates to a fluid control apparatus used for a fluid transport tube requiring fluid control. In particular, this invention relates to a fluid control apparatus which can control flow rate with high stability and accuracy over a wide flow rate range, and has a compact configuration in which installation space in a semiconductor production equipment can be saved, installation in semiconductor production equipment, maintenance and part changing are facilitated, and the mutual sealability of the parts connected to the tube is high.

### BACKGROUND ART

In the prior art, wet etching is used to etch a wafer surface with a chemical liquid such as fluoric acid diluted with pure water as a step in the semiconductor production process. The concentration of the cleaning water used for wet etching must be controlled with high accuracy. In recent years, the concentration of cleaning water has been controlled mainly according to the flow rate ratio between the pure water and the chemical liquid, and for this purpose, a fluid control apparatus for controlling the flow rate of the pure water and the chemical liquid with a high accuracy finds application.

Various types of fluid control apparatuses have been proposed, and one of them is a pure water flow rate control apparatus 301 for controlling the flow rate at a variable pure water temperature as shown in FIG. 7 (see, for example, Japanese Unexamined Patent Publication No. 11-161342). This control apparatus 301 is configured of a flow rate regulation valve 302 with the opening degree thereof adjusted under the effect of the operating pressure to adjust the flow rate of the pure water, an operating pressure adjust valve 303 for adjusting the operating pressure applied to the flow rate regulation valve 302, a flow rate measuring instrument 304 for measuring the flow rate of the pure water output from the flow rate regulation valve 302 and an on-off valve 305 for allowing or shutting off the flow of the pure water through the flow rate measuring instrument 304, wherein the operating pressure adjusted by the operating pressure adjust valve 303 and the output pressure of the pure water from the flow rate regulation valve 302 are maintained in equilibrium with each other thereby controlling the constant flow rate of the pure water output from the flow rate regulation valve 302, characterized in that the measurement of the flow rate measuring instrument 304 is maintained at a constant value by a control circuit for feedback control of the operating pressure supplied from the operating pressure adjust valve 303 to the flow rate regulation valve 302 based on the particular measurement. The advantage of this apparatus is that even when the output pressure of the flow rate regulation valve 302 undergoes a change in the temperature of the pure water, the operating pressure is adjusted in real time in accordance with the output pressure change to regulate the flow rate of the pure water output from the flow rate regulation valve 302, thereby making it possible to maintain the flow rate of the pure water at a constant valve with a high accuracy.

Also, a fluid control module 306 connected in line to a fluid circuit for transporting the fluid as shown in FIG. 8 can be used as an electrically driven fluid control apparatus with the component parts arranged in a single casing (see, for example, Japanese Unexamined Patent Publication No. 2001-242940). This fluid control module 306 is configured of a housing 307 having a chemically inert flow path, an adjustable control valve 308 connected to the flow path, a pressure sensor 309 connected to the flow path and a reduction unit 310 located in the flow path, wherein the control valve 308 and the pressure sensor 309 are accommodated in the housing 307, and wherein a driver 311 having an electric motor for electrically driving the control valve 308 and a controller 312 electrically connected to the control valve 308 and the pressure sensor 309 are further accommodated in the housing 307. The advantage of this module is that the flow rate in the flow path is measured from the pressure difference measured in the fluid circuit and the diameter of the reduction unit 310, and based on the flow rate thus measured, the control valve 308 is driven by feedback control, thereby making it possible to determine the flow rate in the flow path with a high accuracy.

### DISCLOSURE OF THE INVENTION

### Problem to be Solved by the Invention

A conventional pure water flow rate control apparatus 301, in which the flow rate of the pure water output from the flow rate regulation valve 302 is controlled to a constant value by maintaining the equilibrium between the operating pressure adjusted by the operating pressure adjust valve 303 and the output pressure of the pure water in the flow rate regulation valve 302, poses the problem that it is not suitable for controlling the flow rate in detail and the controllable flow rate range is so narrow that it is not easy to control the flow rate over a wide flow rate range. Also, since the component elements are separated by way of flow paths of pipes or tubes, a large installation space is required, for example, when applied in the semiconductor production equipment, and further time-consuming complicated pipe connection, electric wiring and air piping are required for each component element, which may cause a connection error of the pipes and wiring.

On the other hand, in the flow rate control module 306 described above, the portion of the control valve 308 for controlling the fluid is configured so that the fluid easily stagnate, therefore it has a problem that the slurry is fixed by the fluid stagnation and blocks the fluid flow or often makes it impossible to control the fluid accurately. Also, the combined effect of the bend of the flow path at right angles in the control valve 308 and the arrangement of the reduction unit 310 in the flow path increases the pressure loss. Another problem is that a large opening area cannot be secured at the portion of the control valve 308 where the flow rate is controlled, and therefore, the resulting comparatively small flow rate range makes an application for use with controlling over a wide flow rate range difficult. Further, the integrated configuration of the control valve 308 and the pressure sensor 309 with the flow paths formed in a single member makes it impossible to disassemble the control valve 308 and the pressure sensor 309 separately from each other, thereby posing the problem that the maintenance of each part is difficult, and the whole flow rate control module 306 is required to be replaced to change the parts of the control valve 308 or the pressure sensor 309 which may be broken. The resulting great waste leads to an expensive changing of parts.

This invention has been achieved in view of the these problem points of the prior art, and the object thereof is to provide a fluid control apparatus which can control the flow rate with high stability and accuracy over a wide flow rate range, can reduce the installation space in the semiconductor production equipment due to a compact configuration, facilitates the job of installation in the semiconductor production equipment, maintenance and changing the parts, and has a high sealability between the parts connected to the tube.

### Means for Solving the Problem

The configuration of the fluid control apparatus according to this invention to solve the aforementioned problems is explained with reference to the drawings.

According to a first aspect of the invention, there is provided a fluid control apparatus comprising: a measuring instrument for measuring the characteristics of the fluid flowing in the flow path, converting the measurement of the characteristics into an electrical signal and outputting the electrical signal, a fluid control pipe member with a body in which a tube forming the flow path to control the fluid flow rate by changing the opening area of the tube is arranged, and a control unit for controlling, by feedback, the adjustment of the opening degree of the fluid control pipe member based on the electrical signal from the measuring instrument; wherein the fluid control pipe member includes a first coupling unit and a second coupling unit each having an insert portion fitted in the tube in watertight state at one end thereof, a connection unit at the other end thereof and a flange at the intermediate portion thereof, and a holding unit formed with a through-hole at the center thereof and a large-diameter portion fitted with a tube in the state fitted on the insert portion at one end of the through-hole; wherein the tube is arranged via the through-hole of the holding unit, and the assembly of the insert portion of the first and second coupling units fitted at the two ends of the tube is fitted on a large-diameter portion of the holding unit; wherein the flange of the second coupling unit and the holding unit are fixed in pressure contact between the fluid control pipe member and the measuring instrument; and wherein the connection unit of the second coupling unit is connected directly to the fluid inlet or the fluid outlet of the measuring instrument.

According to a second aspect of the invention, there is provided a fluid control apparatus, wherein the fluid inlet or the fluid outlet of the measuring instrument has a fitting portion, and the connection unit of the second coupling unit is directly connected by being fitted on the fitting portion of the measuring instrument in watertight state.

According to a third aspect of the invention, there is provided a fluid control apparatus, wherein the fluid inlet or the fluid outlet of the measuring instrument is directly connected to the connection unit of the second coupling unit by thermal welding, ultrasonic fusion or bonding.

According to a fourth aspect of the invention, there is provided a fluid control apparatus, wherein the fluid control pipe member is a pinch valve, wherein the body of the fluid control pipe member includes a press element having a straight groove for receiving the tube on the flow path axis and a fitting groove formed deeper than the straight groove on at least one end of the straight groove, and the fluid control apparatus further comprising a press element to change opening area of the tube by pressing or releasing the tube, and a drive unit fixedly coupled on the upper part of the body of the fluid control member to move the press element vertically, and wherein at least the flange of the first coupling unit and the holding unit are fitted in the fitting groove in pressure contact.

According to a fifth aspect of the invention, there is provided a fluid control apparatus, wherein the drive unit includes a motor unit arranged above the bonnet and a stem for vertically moving the press element by driving the motor unit, and wherein the press element is arranged under the stem.

According to a sixth aspect of the invention, there is provided a fluid control apparatus, wherein the drive unit includes a cylinder body having a cylinder part therein and a cylinder cover integrated with the upper part thereof, a piston able to slide up and down on the inner circumferential surface of the cylinder part in a sealing state and having a connecting part vertically protruded from the center so as to pass through a through-hole provided in the center of the bottom surface of the cylinder body in a sealing state, and air ports provided at the circumferential side surface of the cylinder body, and communicating with a first space formed surrounded by the bottom surface and the inner circumferential surface of the cylinder part and the bottom end surface of the piston and a second space formed surrounded by the bottom end surface of the cylinder cover and the top surface of the piston, and wherein the press element is fixed at the bottom end of the connecting part.

According to a seventh aspect of the invention, there is provided a fluid control apparatus, wherein the measuring instrument includes a sensor unit for measuring the characteristics of the fluid flowing through the flow path and an amplifier unit for calculating the fluid characteristics by receiving the electrical signal measured by the measuring instrument, and wherein at least the sensor unit and the fluid control pipe member are arranged in a single casing.

According to an eighth aspect of the invention, there is provided a fluid control apparatus, wherein the measuring instrument includes at least one of the flowmeter, the pressure gauge, the thermometer, the densitometer and the current meter.

According to a ninth aspect of the invention, there is provided a fluid control apparatus, wherein the measuring instrument is a flow rate measuring instrument including: a continuous arrangement of an inlet flow path communicating with a fluid inlet, a first rise flow path vertically arranged from the inlet flow path, a straight flow path communicating with the first rise flow path and formed substantially in parallel to the inlet flow path axis, a second rise flow path vertically arranged on the straight flow path and an outlet flow path communicating with the second rise flow path in the direction substantially in parallel to the inlet flow path axis and communicating also with the fluid outlet; a sensor unit having a pair of ultrasonic vibrators arranged in opposed relation to each other at the position of the side walls of the first and second rise flow paths crossing the axis of the straight flow path; and an amplifier unit connected to the ultrasonic vibrators through a cable; wherein the ultrasonic vibrators are switched alternately between transmission and reception and the difference in the propagation time of the ultrasonic wave between the ultrasonic vibrators is measured thereby to calculate the flow rate of the fluid flowing through the straight flow path.

According to a tenth aspect of the invention, there is provided a fluid control apparatus, wherein the measuring instrument is a flow rate measuring instrument configured of a tube having a straight flow path communicating with the fluid inlet and the fluid outlet and two ultrasonic transceivers mounted in spaced relation to each other on the outer circumferential surface of the tube along the axis thereof, wherein each of the ultrasonic transceivers includes a cylindrical transmission unit fixed on the outer circumferential surface of the tube in such a manner as to surround the tube and an ultrasonic vibrator in the shape of a holed disk surrounding the tube and arranged in spaced relation to the outer circumferential surface of the tube, wherein the transmission unit includes a sensor unit having an axial end surface extending in the direction perpendicular to the axial direction of the tube, the ultrasonic vibrators each having the axial end surface fixed on the axial end surface of the transmission unit, and an amplifier unit connected to the ultrasonic vibrator through a cable, and wherein a voltage is applied between the axial end surfaces of each ultrasonic vibrator so that the ultrasonic vibrator is switched alternately between transmission and reception by expansion and contraction in axial direction, and the difference in the propagation time of the ultrasonic wave is measured between the ultrasonic vibrators thereby to calculate the flow rate of the fluid flowing along the straight flow path.

According to an 11th aspect of the invention, there is provided a fluid control apparatus, wherein the fluid control pipe member is a tube pump.

According to a 12th aspect of the invention, there is provided a fluid control apparatus, wherein the material of the tube is EPDM, fluoro rubber, silicone rubber or a composite material thereof.

According to a 13th aspect of the invention, there is provided a fluid control apparatus, wherein the tube is formed of a composite material of polytetrafluoroethylene and silicone rubber.

### EFFECTS OF THE INVENTION

This invention has the aforementioned structure and exhibits the following superior effects:

(1) Suitable for controlling the flow rate over a wide range, and the flow rate can be controlled to a set flow rate with high accuracy and responsiveness in stable manner by feedback control.

(2) Can be made compact by shortening the distance between the surfaces of the fluid control apparatus, and therefore, the installation space can be reduced. Also, the provision as a single product facilitates installation in semiconductor production equipment or the like.

(3) Each member can be easily assembled and disassembled. Therefore, maintenance is easy and the parts can be easily changed.

(4) Since the tube and the coupling units are fixed by the holding unit in watertight state, the fluid will not leak under a high internal pressure which may be applied, thereby preventing the tube from coming off from the coupling units.

(5) Stress, if exerted on the pipe line, can be received by the coupling units, thereby making the apparatus usable for a long period of time without imposing a burden on the tube.

(6) The connection unit of the coupling units formed with a seal ring groove is connected directly by being fitted in the fitting portion formed at the fluid inlet or the fluid outlet of the measuring instrument. Even in the case where a gap is formed between the measuring instrument and the fluid control pipe member by a creep or a distortion, therefore, the fluid is always positively sealed by the seal portion on the inner circumferential surface of the fitting portion and the outer periphery of the connection unit. Thus, the fluid is prevented from flowing out.

(7) The connection unit of the fluid inlet or the fluid outlet of the measuring instrument and the coupling units is directly connected by thermal welding, ultrasonic fusion or bonding. Thus, the measuring instrument and the fluid control pipe member are formed integrally with each other. The stress, if exerted on the connection unit, therefore, can be received by the coupling units, thereby preventing a stress load from being imposed on the measuring instrument.

### BRIEF DESCRIPTION OF THE DRAWINGS

FIG. 1 is a longitudinal sectional view of a fluid control apparatus according to a first embodiment of this invention.

FIG. 2 is a longitudinal sectional view showing the essential parts in an enlarged form in FIG. 1.

FIG. 3 is an exploded perspective view showing the state before the tube, the coupling units and the holding unit are assembled in the body.

FIG. 4 is a perspective view showing the state in which the tube, the coupling units and the holding unit are assembled in the body.

FIG. 5 is a longitudinal sectional view of the fluid control apparatus according to a second embodiment of the invention.

FIG. 6 is a longitudinal sectional view of the fluid control apparatus according to a third embodiment of the invention.

FIG. 7 is a diagram showing a general configuration of the conventional apparatus for controlling the flow rate of pure water.

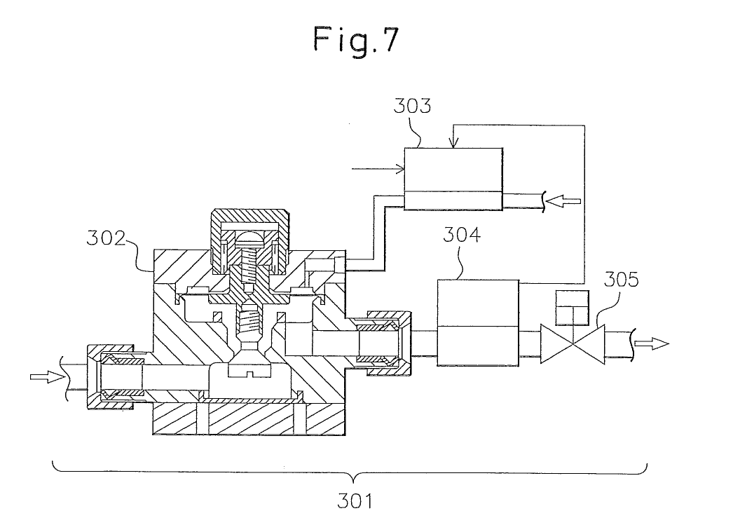

FIG. 8 is a partial sectional view showing the conventional fluid control module.

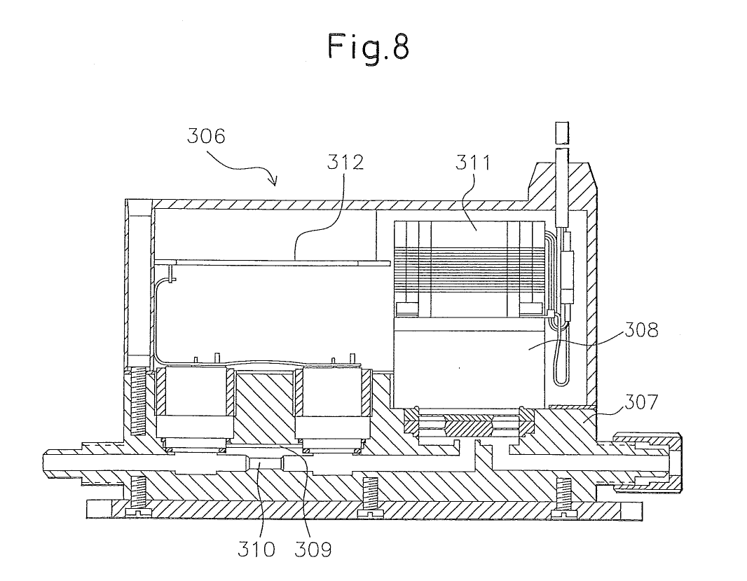

### BEST MODE FOR CARRYING OUT THE INVENTION

The embodiments of the invention are explained below with reference to those shown in the drawings. This invention, however, is not limited to these embodiments.

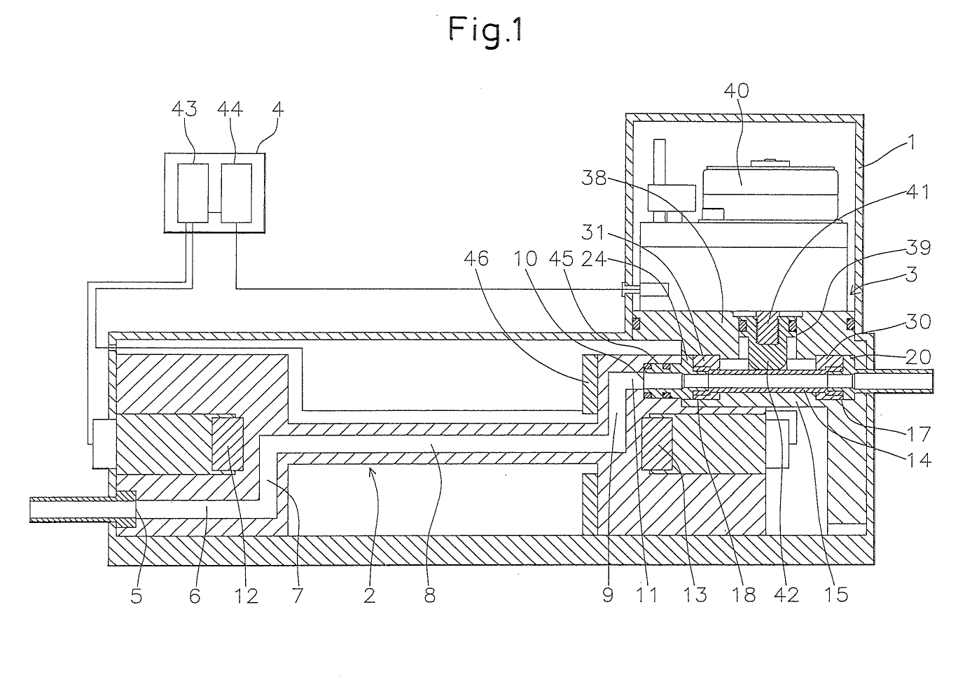

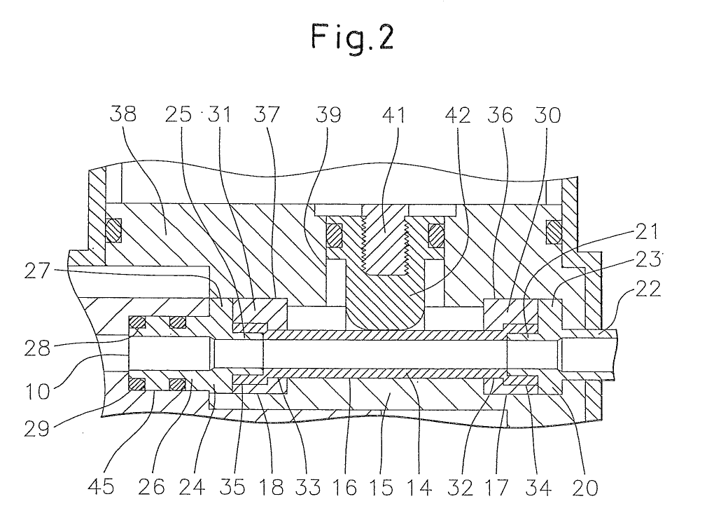

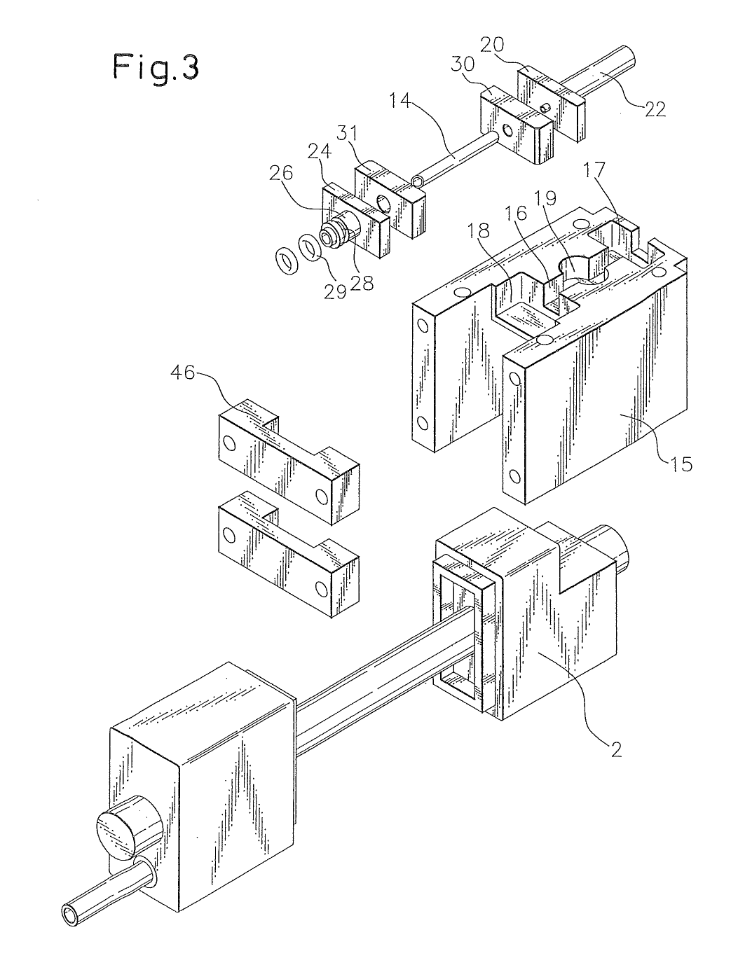

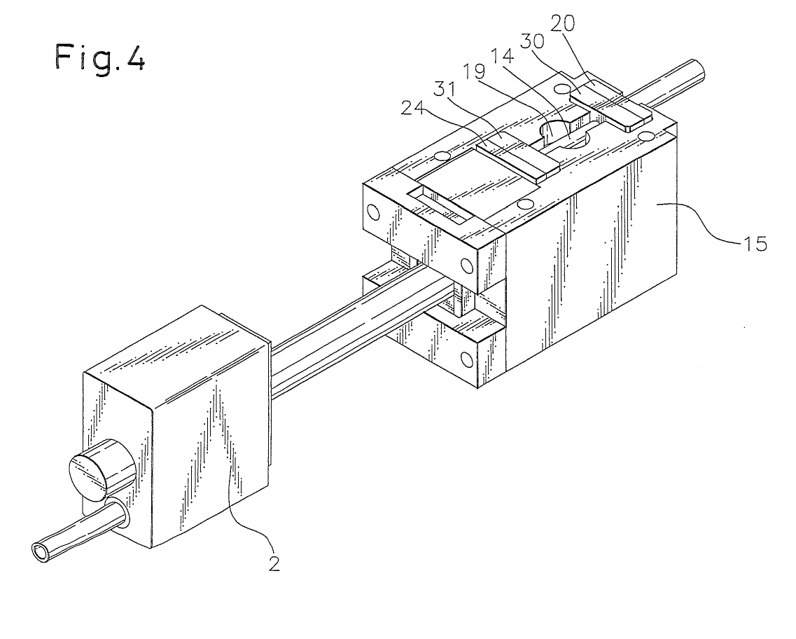

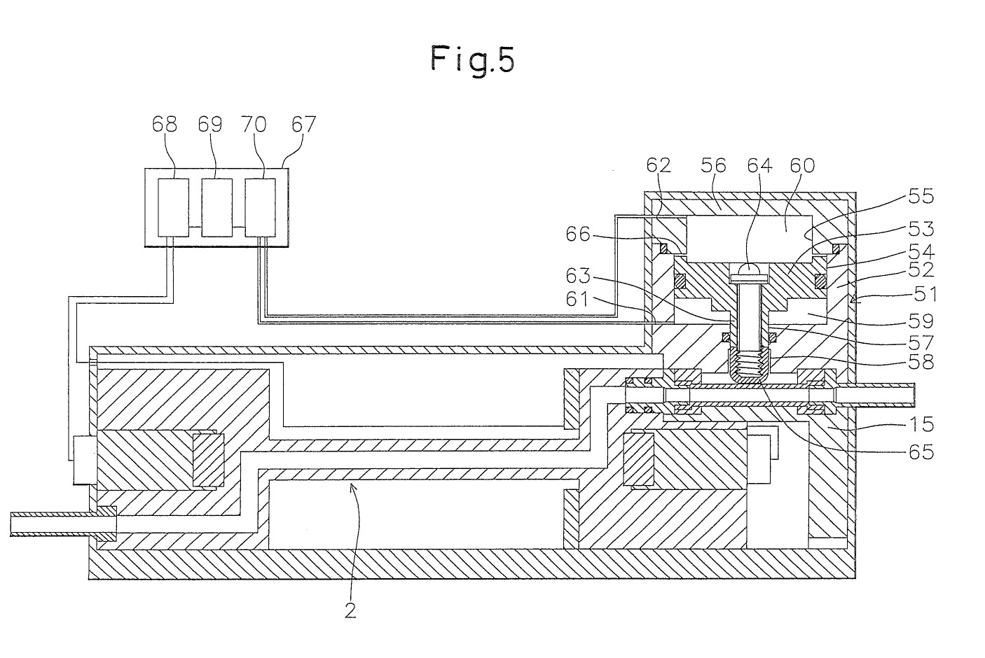

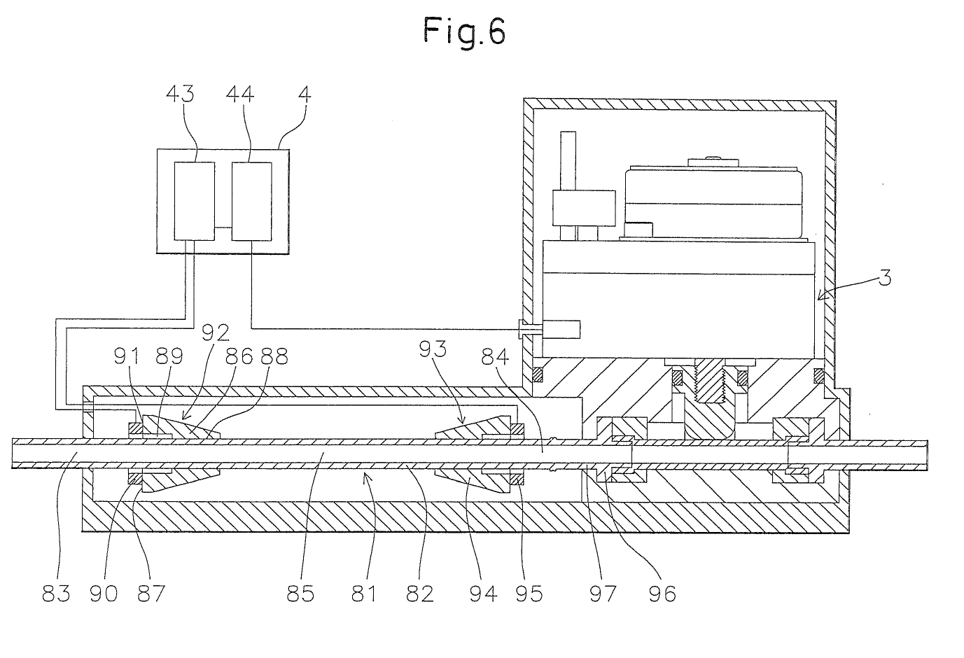

FIG. 1 is a longitudinal sectional view of a fluid control apparatus according to a first embodiment of this invention. FIG. 2 is a longitudinal sectional view of the essential parts in enlarged form in FIG. 1. FIG. 3 is an exploded perspective view showing the state before the tube, the coupling units and the holding unit are assembled in the body. FIG. 4 is a perspective view showing the state in which the tube, the coupling units and the holding unit are assembled in the body. FIG. 5 is a longitudinal sectional view of the fluid control apparatus according to a second embodiment of the invention. FIG. 6 is a longitudinal sectional view of the fluid control apparatus according to a third embodiment of the invention.

In this invention, the fluid characteristics are defined as those measurable in the state of the fluid flowing in the flow path and include, for example, the flow rate, the pressure, the temperature, the concentration and the flow velocity. Also, a measuring instrument 2, which may be any device for measuring the characteristics of the fluid flowing in the flow path and by converting the measurements of the fluid characteristic into an electrical signal, outputting it to a control unit 4, is not specifically limited to the flowmeter, the pressure gauge, the thermometer, the densitometer or the current meter. Also, a plurality of measuring instruments may be used. Especially, in the case where it is desired to measure the flow rate, an ultrasonic flowmeter such as shown in FIG. 1 or 6 is preferable which can measure a minuscule flow rate with high accuracy, has no complicated structure of the flow path and has no obstacle against the fluid flow in the flow path.

The fluid control pipe member according to this invention is configured of a pinch valve or a tube pump especially suitably. The drive unit of the fluid control pipe member applies the power to drive the member for changing the opening area of the internal tube 14. In the pinch valve, a press element 42 for pressing the tube 14 is vertically moved, while in the tube pump, a roller is rotated while pressing the tube. The driving method for the pinch valve is preferably of the electric type as shown in FIG. 1 or the air type as shown in FIG. 5.

In the fluid control pipe member 3 according to this invention, a flange 23 and a holding unit 30 of a first coupling unit 20 are required to be fitted into a first fitting groove 17 of the body 15 in pressure contact. This holds the tube 14 and the first coupling unit 20 in watertight state, and in the case where the internal pressure is applied to the fluid control pipe member 3 or the stress is exerted on the pipe line (not shown) connected to the control pipe member 3, no extraneous load is imposed on the tube 14, thereby suitably preventing the tube 14 from coming off from the first coupling unit 20.

Also, a flange 27 and a holding unit 31 of the second coupling unit 24 are required to be fixed in pressure contact between the fluid control pipe member 3 and the measuring instrument 2 in a second fitting groove 18. In this configuration, the tube 14 and the second coupling unit 24 are held in watertight state, and the connecting portion of the tube 14 can be accommodated in the fluid control pipe member 3 without projecting from the fluid control pipe member 3. Therefore, the space for connection between the fluid control pipe member 3 and the measuring instrument 2 can be reduced to the required minimum, so that the distance between the surfaces of the fluid control apparatus can be suitably reduced into a compact form.

The method of connecting the fluid control pipe member 3 and the measuring instrument 2 desirably employs a configuration in which as shown in FIG. 1, a fitting unit 45 is arranged at the fluid inlet 5 or the fluid outlet 10 of the measuring instrument 2, and the second connection unit 26 of the second coupling unit 24 formed with a seal ring groove on the outer periphery thereof is directly connected by being fitted in the fitting portion 45 of the measuring instrument 2, or a configuration in which as shown in FIG. 6, the fluid inlet 83 or the fluid outlet 84 of the measuring instrument 81 is directly connected to the second connection unit 97 of the second coupling unit 96 by thermal welding, ultrasonic fusion or bonding. The wording “direct connection” is defined as the fact that the second coupling unit 24 of the fluid control pipe member 3 is connected to the fluid inlet 5 or the fluid outlet 10 of the measuring instrument 2 without the interposition of a tube or a joint as a separate member. As a result, the fluid control pipe member 3 and the measuring instrument 2, 81 can be connected without any connection space, and therefore, the distance between the surfaces of the fluid control apparatus can be suitably reduced into a compact form.

Also, the fluid control apparatus according to this invention is employed for any application in which the flow rate of the fluid is required to be controlled at an arbitrary constant value. Nevertheless, the arrangement thereof in the semiconductor production equipment is suitable. The preliminary process for semiconductor fabrication includes the photoresist step, the pattern exposure step, the etching step and the flattening step, and the fluid control apparatus according to this invention is suitably used for controlling the concentration of the cleaning water for these steps by the flow ratio between the pure water and the chemical liquid.

The material of the tube 14 of the fluid control pipe member 3 according to this invention is not specifically limited and includes an elastic one such as EPDM, silicone rubber, fluoric rubber or a composite material thereof. Nevertheless, the composite material of fluoric rubber and silicone rubber with high durability against the repetitive on-off operation is suitable. The fluoric rubber is preferably polytetrafluoroethylene (hereinafter referred to as PTFE). Also, the method of fabricating the tube 14 is not specifically limited, and a PTFE sheet soaked with silicon rubber, for example, is formed in multiple layers to the target thickness.

Also, the material of such parts as the casing 1, the measuring instrument 2 and the fluid control pipe member 3 according to this invention may be any resin such as polyvinyl chloride, polypropylene (hereinafter referred to as PP) or polyethylene. Especially, in the case where the fluid is corrosive, the fluoric resin such as PTFE, polyvinylidene fluoride (hereinafter referred to as PVDF), tetrafluoroethylene-per-fluoroalkylvinyl ether copolymer resin is preferable. Such a fluoric resin can be used for the corrosive fluid, and even in the case where the corrosive gas is transmitted therethrough, the fluid control pipe member 3 or the measuring instrument 2 is not liable to be corroded.

### Embodiment 1

A fluid control apparatus according to a first embodiment of the invention in which the fluid control pipe member is an electric pinch valve is explained with reference to FIGS. 1 to 3.

Numeral 1 designates a PVDF casing. In the casing 1, the measuring instrument 2 and the electric pinch valve 3 are fixed with bolts and nuts (not shown) on the bottom surface of the casing 1, and from the upstream side, the measuring instrument 2 and the electric pinch valve 3 are installed in that order in a state directly connected to each other. Incidentally, the measuring instrument 2 and the electric pinch valve 3 may be arranged in the reverse order, in which case the fitting portion 45 is arranged at the fluid inlet 5 of the measuring instrument 2 and the second connection unit 26 of the second coupling unit 24 of the electric pinch valve 3 is directly connected in the state inserted (not shown) in the fitting portion 45.

Numeral 2 designates the measuring instrument for measuring the flow rate. The measuring instrument 2 includes an inlet flow path 6 communicating with the fluid inlet 5, a first rise flow path 7 vertically arranged from the inlet flow path 6, a straight flow path 8 communicating with the first rise flow path 7 and arranged substantially in parallel to the axis of the inlet flow path 6, a second rise flow path 9 vertically arranged from the straight flow path 8, and an outlet flow path 11 communicating with the second rise flow path 9 and the fluid outlet 10 formed substantially in parallel to the axis of the inlet flow path 6.

Ultrasonic vibrators 12, 13 are arranged in opposed relation to each other at positions where the side walls of the first and second rise flow paths 7, 9 cross the axis of the straight flow path 8. The ultrasonic vibrators 12, 13 are covered with fluoric resin, and the wiring extending from the vibrators 12, 13 is connected to the arithmetic unit 43 of the control unit 4 described later. Also, the fitting portion 45 is arranged at the fluid outlet 10 and directly connected, inserted therein, with the second connection unit 26 of the second coupling unit 24 of the electric pinch valve. In the process, the portion making up the measuring instrument 2 constitutes a sensor unit (although a measuring instrument is constructed of a combination of the sensor unit and the amplifier unit described later, the portion corresponding to the sensor unit is referred to as the measuring instrument 2 for convenience' sake according to this embodiment with the sensor unit and the amplifier unit provided as independent members). Incidentally, as shown in FIG. 1, the outlet flow path 11 is minimized in length and the fitting portion 45 is formed at the fluid outlet 10 while at the same time forming the body 15 of the electric pinch valve 3 in a manner conforming with the space formed by the shortened outlet flow path 11, and the measuring instrument 2 is connected to the electric pinch valve 3, thereby making it possible to form a compact fluid control apparatus with the distance shortened between the surfaces thereof.

Numeral 3 designates an electric pinch valve constituting the fluid control pipe member for controlling the fluid flow rate by changing the opening area of the tube 14 by an electric drive unit. The electric pinch valve 3 is configured of a body 15 with the tube 14 arranged thereon and the electric drive unit.

Numeral 14 designates a tube formed of a composite material of fluoro rubber and silicone rubber and making up a flow path in the body 15.

Numeral 15 designates the body made of PVC, in which a straight groove 16 having a rectangular cross section for accepting the tube 14 is formed on the flow path axis of the body 15. Also, a first fitting groove 17 having a rectangular cross section deeper than the straight groove 16 is formed at one end of the straight groove 16 to accept the first coupling unit 20 and the holding unit 30, while a second fitting groove 18 deeper than the straight groove 16 and having a rectangular cross section with an opening on the side thereof near to the measuring instrument 2 is formed at the other end of the straight groove 16 to accept the second coupling unit 24 and the holding unit 31. Further, an oblong groove 19 along which the press element 42 having the same depth as the straight groove 16 and including a vertically movable press element 42 is formed at the intermediate portion of the straight groove 16 (FIG. 3).

Numeral 20 designates the first coupling unit formed of PFA. An insert portion 21 having the outer diameter larger than the inner diameter of the tube 14 and the inner diameter substantially equal to the inner diameter of the tube 14 is formed at one end of the first coupling unit in such a manner as to be insertable into the two ends of the tube 14. A tubular first connection unit 22 connected to the pipe extending from the pipe line is arranged at the other end the first coupling unit 20, and a flange 23 adapted to be fitted in the first fitting groove 17 is arranged at the intermediate portion of the first coupling unit 20. Incidentally, the first connection unit 22, though tubular according to this embodiment, may alternatively be a joint or a threaded groove depending on the method of connection with the pipe line (not shown).

Numeral 24 designates the second coupling unit of PFA, including an insert portion 25, a second connection unit 26 and a flange 27. Two annular grooves 28 are formed on the outer periphery of the second connection unit 26, and the annular groove 28 near to the end surface is formed as a notch cut in the wall near to the end surface. An O-ring 29 is mounted in each of the annular grooves 28. The O-ring 29 has a sectional diameter slightly larger than the width of the annular groove 28, and in the case where the second connection unit 26 is fitted in the fitting portion 45, is held in the state sealed with the circumferential surface of the annular groove 28 and the inner circumferential surface of the fitting portion 45 (the annular groove 28 near to the end surface is sealed with the bottom surface of the fitting portion 45). The other parts of the configuration of the second coupling unit 24 are similar to those of the first coupling unit 20, and therefore, not described any further.

Numerals 30, 31 are holding units of PVC. Through-holes 32, 33 are formed at the center of the holding units 30, 31, and at one end of the through-holes 32, 33, large-diameter portions 34, 35 are arranged which have the inner diameter substantially equal to the outer diameter of the tube 14 into which the insert portions 21, 25 of the first and second coupling units 20, 24 are inserted.

The first and second coupling units 20, 24 and the holding units 30, 31 are such that the large-diameter portions 34, 35 of the holding units 30, 31 are fitted in the state in which the ends of the tube 14 passed through the through-holes 32, 33, respectively, of the holding units 30, 31 and the insert portions 21, 25 of the first and second coupling units 20, 24 are fitted at the ends of the tube 14. The tube 14 is inserted in the straight groove 16 of the body 15, and with the flange 23 of the first coupling unit 20 in pressure contact with the holding unit 30, is fixedly fitted in the first fitting groove 17 of the body 15. The resulting assembly is fitted in the second fitting groove 18 of the body 15 in the state in which the flange 27 of the second coupling unit 24 and the holding unit 31 are in contact with each other. Next, the second connection unit 26 of the second coupling unit 24 is inserted in the fitting portion 45 of the measuring instrument 2, and the body 15 and the measuring instrument 2 are bolted (not shown) to each other with a fixing member 46, so that the flange 27 of the second coupling unit 24 and the holding unit 31 are fixed in pressure contact with each other in the second fitting groove 18 (the state shown in FIG. 4).

The flanges 23, 27 of the first coupling unit 20 and the second coupling unit 24 and the holding units 30, 31 are formed substantially into a parallelepiped when brought into pressure contact with each other, and while in pressure contact, fitted in the first fitting groove 17 and the second fitting groove 18, respectively, of the body 15. In this case, the first fitting groove 17 and the second fitting groove 18 of the body 15 desirably have such a height that the large-diameter portions 34, of the holding units 30, 31 are fully accommodated in the first fitting groove 17 and the second fitting groove 18, respectively, of the body 15. By doing so, a uniform pressure is imparted with a constant force to the portion where the tube 14 is fitted with the insert portions 21, of the first coupling unit 20 and the second coupling unit 24, so that the tube 14 can be uniformly sealed over the entire periphery in a suitable manner. Also, it is desired that the height of the flanges 23, 27 of the first coupling unit 20 and the second coupling unit 24 and the holding units 30, 31 is slightly larger than the height of the first fitting groove 17 and the second fitting groove 18 of the body 15 in such a manner that when fitted in the first fitting groove 17 and the second fitting groove 18, the upper portions of the flanges 23, 27, etc. are projected slightly from the upper surface of the body 15 (FIG. 4). As a result, the depressions 36, 37 adapted to be fitted on the projected upper portions of the flange 23 of the first coupling unit 20 and the holding unit 30 and the upper portions of the flange 27 of the second coupling unit 24 and the holding unit 31 are arranged on the lower surface of the bonnet 38 of the electric drive unit suitably to facilitate the positioning of the body 15 and the electric drive unit at the time of assembly work. Incidentally, the shape of the flange 23 of the first coupling unit 20 and the holding unit 30 and the first fitting groove 17 is not specifically limited as long as the flange 23 of the first coupling unit 20 and the holding unit 30 in pressure contact with each other can be fitted in the first fitting groove 17. Similarly, the shape of the flange 27 of the second fitting groove 24 and the holding unit 31 and the second fitting groove 18 are not specifically limited as long as the flange 27 of the second coupling unit 24 and the holding unit 31 fitted in the second fitting groove 18 can be fixed in pressure contact by the electric pinch valve 3 and the measuring instrument 2.

The electric drive unit is formed of a bonnet 38, a motor unit 40 and a press element 42 and fixed in contact with the upper part of the body 15 with bolts and nuts (not shown). This configuration is described below.

Numeral 38 designates a tabular bonnet of PVC with a through-hole 39 formed at the intermediate portion thereof. Also, on the lower surface of the bonnet 38, there are formed depressions 36, 37 which are fitted with that portion of the flange 23 of the first coupling unit 20 and the holding unit 30 which is projected from the upper surface of the body 15 and that portion of the flange 27 of the second coupling unit 24 and the holding unit 31 which is projected from the upper surface of the body 15.

Numeral 40 designates a motor unit installed above the bonnet 38. The motor unit 40 has a stepping motor and a stem 41 coupled to the motor shaft through a gear (not shown) under the motor unit 40. The stem 41 is located in the through-hole 39 of the bonnet 38, and the press element 42 described later is fixed at the lower end of the stem 41. By driving the motor unit 40, the step 41 is moved up and down so that the press element 42 presses or releases the tube 14. Incidentally, according to this embodiment, the press element 42 is fixed at the lower end of the stem 41 and moved up and down by moving the stem 41 up and down with the electric drive unit. Alternatively, a configuration may be employed in which an externally threaded portion is formed on the stem 41 and the press element 42 formed with an internally threaded portion on the inner periphery thereof is screwed with the lower part of the stem 41, so that the press element 42 is held unrotatably and the stem 41 is rotated with the electric drive unit thereby to move the press element 42 up and down.

Numeral 42 designates the press element of which the part pressing the tube 14 is formed with a semicircular cross section. This press element is fixed at the forward end of the stem 41 at right angles to the tube 14, and when the valve is closed, inserted in the oblong groove 19 of the body thereby to press the tube 14, while when the valve is open, releases the tube 14 and is accommodated in the through-hole 39 of the bonnet 38 (FIG. 1).

Numeral 4 designates the control unit. The control unit 4 includes an arithmetic unit 43 for calculating the flow rate from the signal output from the measuring instrument 2 and a controller 44 for feedback control. The arithmetic unit 43 includes a transmission circuit for outputting the ultrasonic vibration at predetermined time intervals to the ultrasonic vibrator 12 at the transmitting end, a receiving circuit for receiving the ultrasonic vibration from the ultrasonic vibrator 13 at the receiving end, a comparator circuit for comparing the propagation time of each ultrasonic vibration, and an arithmetic circuit for calculating the flow rate from the propagation time difference output from the comparator circuit. The controller 44 includes a control circuit for activating the motor unit 40 of the electric drive unit so that the flow rate output from the arithmetic unit 43 assumes a set flow rate. In the process, an amplifier unit is constituted of the arithmetic unit 43 of the control unit 4 to calculate the flow rate from the signal output from the sensor unit forming the measuring instrument 2. Incidentally, although this embodiment is so configured that the control unit 4 is arranged outside of the casing 1 as a member (with the sensor unit arranged in the casing 1 and the amplifier unit in the control unit 4) independent of the fluid control apparatus to perform the centralized control operation, the configuration may alternatively be employed in which the control unit 4 is arranged integrally in the casing 1 (in the fluid control apparatus). In the process, the amplifier unit is desirably arranged in the casing 1 in the state protected by a protective member such as a box. Also, the arithmetic unit 43, in which the measuring instrument 2 constituting the flowmeter calculates the flow rate, alternatively calculates the characteristics of the fluid involved which may be the pressure, the temperature, the concentration or the flow velocity.

Next, the operation of the fluid control apparatus according to a first embodiment of the invention is explained.

The fluid that has entered the fluid control apparatus first flows into the measuring instrument 2 in which the flow rate of the fluid passing through the straight flow path 8 is measured. The ultrasonic vibration is propagated from the ultrasonic vibrator 12 located on the upstream side toward the ultrasonic vibrator 13 located on the downstream side in the fluid flow. The ultrasonic vibration received by the ultrasonic vibrator 13 is converted into an electrical signal and output to the arithmetic unit 43 of the control unit 4. In the case where the ultrasonic vibration is received by being propagated from the ultrasonic vibrator 12 on the upstream side to the ultrasonic vibrator 13 on the downstream side, the transmission and the reception are instantaneously switched in the arithmetic unit 43, so that the ultrasonic vibration is propagated from the ultrasonic vibrator 13 on the downstream side toward the ultrasonic vibrator 12 located on the upstream side. The ultrasonic vibration received by the ultrasonic vibrator 12 is converted into an electrical signal and output to the arithmetic unit 43 in the control unit 4. In the process, the ultrasonic vibration is propagated against the fluid flow in the straight flow path 8, and therefore, as compared with the propagation of the ultrasonic vibration from the upstream toward the downstream side, the propagation speed of the ultrasonic vibration in the fluid is retarded and the propagation time lengthened. The propagation time of each of the mutual electrical signals thus output is measured in the arithmetic unit 43 and the flow rate is calculated from the difference in propagation time. The flow rate calculated in the arithmetic unit 43 is converted into an electrical signal and output to the controller 44.

Next, the fluid that has passed through the measuring instrument 2 flows into the electric pinch valve 3. In the controller 44, the signal is output to the electric drive unit in such a manner that the difference between an arbitrary set flow rate and the flow rate measured in real time becomes zero, and the motor unit 40 of the electric drive unit is driven to control the opening degree of the tube 14. The fluid flowing out of the electric pinch valve 3 is controlled by the electric pinch valve 3 in such a manner that the flow rate is equal to the set flow rate, i.e. the difference between the set flow rate and the measured flow rate is converged to zero.

The operation of the electric pinch valve 3 due to the transmission from the electric drive unit is described below.

With the downward drive (forward rotation) of the stem 41 by the motor unit 40 of the electric drive unit, the press element 42 arranged under the stem 41 moves down and deforms the tube 14, thereby changing the opening area of the flow path of the tube 14. As a result, the flow rate of the fluid flowing through the electric pinch valve 3 can be adjusted. With the drive of the stem 41 further downward, the press element 42 moves down and by pressing the tube 14, shuts off the flow path into closed-up state. With the upward drive (reverse rotation) of the stem 41, on the other hand, the press element 42 arranged under the stem 41 is moved up and accommodated in the through-hole 39 of the bonnet 38. Then, the stem 41 and the press element 42 stop into a full open state (the state shown in FIG. 1).

By the operation described above, the electric drive unit can easily control the drive of the electrically-driven motor unit 40 in more detail with high responsiveness. Thus, a superior effect is exhibited for controlling the fluid of a minuscule flow rate, so that the fluid flowing in the fluid control apparatus is controlled at a constant set flow rate.

The flow path of the fluid control apparatus has a part bent at right angles in the measuring instrument 2.

Nevertheless, there is no part for reducing the flow path, and the flow path in the electric pinch valve 3 is straight. Therefore, the pressure loss is minimized. Since there is no portion where the fluid stagnates, the slurry is not easily attached at the points where the flow rate is controlled, in an application to a line for transporting the slurry, and therefore, the stable fluid control operation can be maintained. Also, in the electric pinch valve 3, the tube 14 forms the flow path and changes the opening area thereof. Therefore, the flow rate can be controlled over a wide flow rate range. Further, since the sliding portion of the valve is separately configured from the flow path, no contamination or particles are generated in the flow path.

For connecting the electric pinch valve 3 and the measuring instrument 2, the second connection unit 26 of the second coupling unit 4 is fitted in the fitting portion 45. In view of the fact that the inner circumferential surface of the fitting portion 45 and the outer periphery of the second connection unit 26 collaborate with the O-ring 29 for double seal, the fluid is positively kept sealed by the seal portion formed of the inner circumferential surface of the fitting portion 45 and the outer periphery of the second connection unit and prevented from flowing out even if a gap is formed due to the creep or distortion between the electric pinch valve 3 and the measuring instrument 2.

Also, the first and second coupling units 20, 24 and the holding units 30, 31 in pressure contact with each other are fitted in the first and second fitting grooves 17, 18, respectively, and therefore, the tube 14 and the insert portions 21, 25 of the first and second coupling units 20, 24 are positively kept in watertight state over the whole periphery thereof by the large-diameter portions 34, 35 of the holding units 30, 31. Further, the watertight state is further improved by the portion constituting the step between the large-diameter portions 34, 35 of the holding units 30, 31 and the through-holes 32, 33. Even under high internal pressure, the force is added to strengthen the seal correspondingly. Thus, the fluid will not leak and the tube 14 is prevented from coming off from the first and second coupling units 20, 24. Also, since the first coupling unit 20 and the holding unit 30 are fixed by the body 15, a stress, if exerted on the pipe line in the direction of tension or compression, can be received by the first coupling unit 20. The tube 14, therefore, can be used for a long time free of the load thereon. Incidentally, the tube 14 and the first and second coupling units 20, 24 may be fitted on each other through an O-ring, etc. if required.

Also, the member for connecting the tube 14 in the electric pinch valve 3 occupies no large space along the direction of the flow path, and therefore, the distance between the surfaces of the electric pinch valve 3 can be shortened. Further, the connection structure of the electric pinch valve 3 and the measuring instrument 2 is such that the side surface of the electric pinch valve 3 and the side surface of the measuring instrument 2 can be connected to each other by contact without any connection space. Thus, the distance between the surfaces of the fluid control apparatus is shortened into a compact form, and therefore, the installation space of the fluid control apparatus can be reduced. Also, the number of parts used at the portion where the electric pinch valve 3 and the measuring instrument 2 are connected to each other is reduced. The parts can be fitted or inserted in each other and assembled, and therefore, the assembly work is easy. Also, when maintenance is carried out on the fluid control apparatus, the apparatus can be disassembled for each member, thereby facilitating the maintenance and making it possible to change the parts for each member. Also, as shown in FIG. 3, the parts are simplified in shape, and therefore, can be easily processed. Incidentally, with a configuration in which a similar fitting unit is arranged at the fluid inlet or the fluid outlet of the measuring instrument for conducting other measurements, the requirement of the measurement of all fluids can be met suitably by changing the measuring instrument 2.

Also, the fluid control apparatus is installed in a single casing 1, and therefore, the electric pinch valve 3 and the measuring instrument 2 are protected by the casing 1. Thus, the fluid control apparatus can be installed as one product not bulky in semiconductor production equipment, thereby facilitating the installation. Since the wiring is laid already in the casing 1, the wiring job can be easily accomplished simply by connecting to the external devices using the connector or the like. Also, the casing 1 can construct the fluid control apparatus as a black box, thereby suitably making it possible to avoid the inconvenience which otherwise might be caused by the semiconductor production equipment user unduly disassembling the fluid control apparatus installed in the semiconductor production equipment.

### Embodiment 2

Next, the fluid control apparatus according to a second embodiment of the invention in which the fluid control pipe member is a pneumatic pinch valve is explained with reference to FIG. 5. The component elements similar to those of the first embodiment are designated by the same reference numerals, respectively.

Numeral 51 designates a pneumatic pinch valve constituting the fluid control pipe member for controlling the fluid flow rate by changing the opening area of the flow path in accordance with the operating pressure. The pneumatic pinch valve 51 is configured of a body 15 having a tube 14 and a pneumatic drive unit.

The pneumatic drive unit is formed of a cylinder body 52, a piston 53 and a press element 65, and fixed with bolts and nuts (not shown) in contact with the upper part of the body 15. The configuration of the pneumatic drive unit is described below.

Numeral 52 designates a cylinder body of PVDF. The cylinder body 52 includes a cylinder part 54 having a cylindrical space, and a cylinder cover 56 formed with a depression 55 having an open lower surface is fixed in contact with the upper part of the cylinder body 52 through an O-ring. At the central part of the lower surface of the cylinder body 52, a through-hole 57 in which the coupling unit 63 of the piston 53 described later is passed through and an oblong slit 58 for accommodating the press element 65 described later are arranged continuously. Also, on the circumferential side surface of the cylinder body 52, air port 61, 62 for introducing the compressed air are formed in a first space portion 59 defined by the inner circumferential surface and the bottom surface of the cylinder part 54 and the lower end surface of the piston 53 described later on the one hand and a second space portion 60 defined by the lower end surface of the cylinder cover 56 and the upper end surface of the piston 53 described later on the other hand, respectively.

Numeral 53 designates a piston formed of PVDF. The piston 53, in the shape of a disk and having an O-ring mounted on the circumferential side surface thereof, is fitted vertically movably on the inner circumferential surface of the cylinder part 54 in hermetically sealed state. Also, a coupling unit 63 is vertically arranged from the center of the piston 53, and passed hermetically via the through-hole 57 formed at the center of the lower surface of the cylinder body 52. A press element 65 described later is fixedly screwed at the forward end of the fixing bolt 64 arranged through the coupling unit 63. Incidentally, the method of fixing the press element 65 to the coupling unit 63 is not specifically limited and such a method as pressure fitting, bonding, welding or fixing with pins may be used.

Numeral 65 designates a press element of PVDF of which the portion pressing the tube 14 has a semicircular cross section. Also, the press element 65 is fixed on the coupling unit 63 of the piston 53 in the direction at right angles to the tube 14. Thus, the press element 65 is inserted into the oblong groove of the body 15 and presses the tube 14 when the valve is closed, while the tube 14 is released and the press element 65 is accommodated in the oblong slit 58 of the body 52 when the valve is open.

Numeral 67 designates a control unit. The control unit 67 includes an arithmetic unit 68 for calculating the flow rate from the signal output from the measuring instrument 2 and a controller 69 for feedback control.

The controller 69 has a control circuit to manipulate the pressure of the control air by controlling an electric-pneumatic converter 70, described later, in such a manner that the flow rate output from the arithmetic unit 68 becomes a set flow rate.

Numeral 70 designates the electric-pneumatic converter for adjusting the operating pressure of the compressed air. The electric-pneumatic converter 70 is configured of an electromagnetic valve electrically driven to adjust the operating pressure proportionately, and in accordance with the control signal from the control unit 67, adjusts the operating pressure of the air to control the pneumatic pinch valve 51.

The remaining component parts of the configuration of the fluid control apparatus are similar to the corresponding parts of the first embodiment, and therefore, not explained any further. Also, the steps of assembling the fluid control apparatus according to the second embodiment are similar to those of the first embodiment except that the body 15 and the pneumatic drive unit are assembled by being fixed with bolts and nuts, and therefore, not explained any more.

Next, the operation of the second embodiment of the invention is explained.

The pneumatic pinch valve 51 operates as described below in response to the operating pressure supplied from the electric-pneumatic converter 70.

In the case where the compressed air is supplied from the air port 61 into the first space portion 59, the compressed air in the second space portion 60 is discharged from the air port 62, and by the pressure of the compressed air supplied to the first space portion 59, the piston 53 begins to rise, which in turn moves up the press element 65 through the coupling unit 63 vertically arranged from the piston 53. Once the upper end surface of the piston 53 comes into contact with the stepped portion 66 of the cylinder part 54, the piston 53 and the press element 65 stop moving up, and the press element 65 is accommodated in the through-hole 57 of the cylinder body 52 to assume a full open state. In the case where the compressed air is supplied from the air port 62 into the second space portion 60, on the other hand, the compressed air in the first space portion 59 is discharged from the air port 61 and by the pressure of the compressed air supplied to the second space portion 60, the piston 53 begins to move down, which in turn moves down the press element 65 through the coupling unit 63 protruded from the piston 53. Once the lower end surface of the piston 53 reaches the bottom surface of the cylinder part 54, the downward movement of the piston 53 and the press element 65 stops, so that the tube 14 is pressed to shut off the flow path in the closed-up state. With the vertical movement of the piston 53, the press element 65 also moves vertically and deforms the tube 14. In this way, the opening area of the flow path of the tube 14 is changed thereby to adjust the flow rate of the fluid flowing in the pneumatic pinch valve 51.

Incidentally, in the pneumatic pinch valve 51 according to the second embodiment, a spring (not shown) may be held and supported between the ceiling of the cylinder part 54 of the second space portion 60 and the upper surface of the piston 53 or between the bottom surface of the cylinder part 54 of the first space portion 59 and the lower surface of the piston 53. This configuration can suitably keep the normally closed or normally open state without supplying the working fluid by adding the pressure due to the spring elasticity instead of supplying the working fluid.

Through the operation described above, the pneumatic drive unit is pneumatically driven without using the electric parts liable to be corroded in the pneumatic pinch valve 51. Thus, the corrosion of the parts of the pneumatic pinch valve 51 is prevented which otherwise might be caused by the transmission of the corrosive gas when a corrosive fluid is supplied. In this way, the fluid flowing in the fluid control apparatus is controlled at a constant set flow rate. The other operation of the second embodiment is similar to the corresponding operation of the first embodiment, and therefore, not described any more.

### Embodiment 3

Next, a third embodiment of the invention is explained with reference to FIG. 6. This explanation represents a case in which the measuring instrument according to the first embodiment is a measuring instrument 81 constituting a different ultrasonic flowmeter. The component elements similar to those of the first embodiment are designated by the same reference numerals, respectively.

Numeral 82 designates a measuring tube of fluoro resin. The measuring tube 82 has a straight flow path 85 communicating with the fluid inlet 83 and the fluid outlet 84.

Numeral 86 designates a transmission unit of duralumin. The transmission unit 86 is substantially conical and arranged in such a manner as to surround the measuring tube 82. The axial end surface 87 on the large-diameter side of the transmission unit 86 is formed perpendicular to the axial direction of the measuring tube 82. Also, through-holes including a front through-hole 88 and a rear through-hole 89 are formed at the center of the transmission unit 86. The rear through-hole 89 has a larger diameter than the front through-hole 88. In the case where the inner circumferential surface of the front through-hole 88 is closely fixed to the outer circumferential surface of the measuring tube 82 with epoxy resin adhesive, the inner circumferential surface of the rear through-hole 89 is spaced from the measuring tube 82. Incidentally, although the transmission unit 86 is formed of duralumin according to this embodiment, any other material high in ultrasonic wave propagation characteristic may be used such as a metal including aluminum, aluminum alloy, titanium, hastelloy or SUS or synthetic resin such as fluoro resin, glass or quartz. Also, in spite of the fact that the shape of the transmission unit 86 is described as substantially conical, any other shape may be employed as far as the propagation characteristic of the ultrasonic vibration is high. Also, in place of the epoxy resin adhesive for closely fixing the front through-hole 88, any of various other bonding agents such as grease may be used as far as the ultrasonic vibration from the ultrasonic vibrator 90 fails to be transmitted directly to the measuring tube 82. Also, in the case where the transmission unit 86 and the measuring tube 82 are of the same material, the thermal welding may be used for the fixing process, or the simple pressure fitting may be employed for the closely fixing process.

Numeral 90 designates an ultrasonic vibrator of a piezoelectric material such as lead titanite zirconate (PZT), and the ultrasonic vibrator 90 is in the shape of a donut, i.e. a holed disk. One axial end surface 91 of the ultrasonic vibrator 90 is bonded under pressure by epoxy resin to the whole axial end surface 87 of the transmission unit 86, while the other axial end surface and the outer circumferential surface of the ultrasonic vibrator 90 are coated or bonded with a damper (not shown) and closely fixed. The inner diameter of the ultrasonic vibrator 90 is substantially equal to the diameter of the rear through-hole 89 of the transmission unit 86, and the inner circumferential surface thereof is spaced from the outer circumferential surface of the measuring tube 82. Also, the axial end surface 91 electrically constitutes an earth terminal The ultrasonic transceiver 92 on the upstream side is configured by closely fixing the ultrasonic vibrator 90 on the transmission unit 86. Incidentally, according to this embodiment, the ultrasonic vibrator 90 is in the shape of a holed disk. Nevertheless, a semicircle or a fan shape may alternatively be employed. Also, the inner circumferential surface of the ultrasonic vibrator 90, though spaced from the outer circumferential surface of the measuring tube 82, may alternatively be closely fixed on the measuring tube 82 through a material (damper) for shutting off the ultrasonic vibration.

The ultrasonic transceiver 93 on the downstream side also has a similar configuration to the ultrasonic transceiver 92 on the upstream side. The two ultrasonic transceivers 92, 93 are arranged in spaced relation to each other on the outer periphery of the measuring tube 6 in opposed relation to the transmission units 86, 94, respectively. Also, the wiring extending from the ultrasonic vibrators 90, 95 is connected to the arithmetic unit 43 of the control unit 4. In the process, the portion making up the measuring instrument 81 is a sensor unit, and the arithmetic unit 43 of the control unit 4 for calculating the flow rate from the signal output from the sensor unit forming the measuring instrument 81 constitutes an amplifier unit. Incidentally, the sensor unit of the measuring instrument 81 and the amplifier unit may be arranged separately from each other or integrally with each other.

The structure of connecting the electric pinch valve 3 and the measuring instrument 81 is such that the connection unit 97 of the second coupling unit 96 of the electric pinch valve 3 is formed as a tubular member having the same diameter as the measuring tube 82, and the end surfaces of the fluid outlet 84 of the measuring tube 82 and the connection unit 97 of the second coupling unit 96 are connected to each other by butt fusion. The other component parts of the configuration according to the third embodiment are similar to the corresponding parts of the first embodiment, and therefore, not explained any more.

Next, the operation of the third embodiment of the invention is explained.

The fluid that has flowed into the fluid control apparatus flows into the measuring instrument 81 where the flow rate is measured in the straight flow path 85 of the measuring tube 82. Upon application of a voltage from the control unit 4 to the ultrasonic vibrator 90 of the ultrasonic transceiver 92 located on upstream side in the fluid flow, the ultrasonic vibrator 90 develops a vibration in the direction along the thickness (the direction in which the voltage is applied) and the direction along the diameter (the direction perpendicular to the direction of voltage application). The ultrasonic transceiver 92, by applying a voltage between the two axial end surfaces of the ultrasonic vibrator 90, propagates the ultrasonic vibration in the direction along the thickness larger in vibration energy as an ultrasonic wave to the axial end surface 91 of the transmission unit 86. The ultrasonic vibration along the diameter of the ultrasonic vibrator 90, on the other hand, is absorbed into the damper while at the same time removing the ultrasonic reverberation. Therefore, the ultrasonic vibration is not propagated to the surrounding.

The ultrasonic vibration that has propagated to the transmission unit 86 further propagates toward the front through-hole 88 in the transmission unit 86. The ultrasonic vibration that has propagated to the front through-hole 88, after being transmitted into the fluid of the measuring tube 82 through the tube wall from the whole outer periphery of the tube in the form strengthened in directivity toward the center of the measuring tube 82, is estimated to propagate while fanning out in the direction substantially in parallel to the tube axis in the fluid. The ultrasonic vibration then is transmitted into the transmission unit 94 of the ultrasonic transceiver 93 located in opposed relation thereto on the downstream side, and after being converted into an electrical signal, output to the arithmetic unit 43 in the control unit 4.

Once the ultrasonic vibration is transmitted from the ultrasonic transceiver 92 on the upstream side to and received by the ultrasonic transceiver 93 on the downstream side, the transmission and the reception are instantaneously switched in the converter, and the ultrasonic vibration is propagated similarly from the ultrasonic vibrator 95 of the ultrasonic transceiver 93 located on the downstream side toward the ultrasonic vibrator 90 of the ultrasonic transceiver 92 located on the upstream side. The ultrasonic vibration received by the ultrasonic vibrator 90 is converted into an electrical signal and output to the arithmetic unit 43 in the control unit 4. In the process, the ultrasonic vibration is propagated against the fluid flow in the straight flow path 85, and therefore, compared with the propagation of the ultrasonic vibration from upstream to downstream side, the propagation speed of the ultrasonic vibration in the fluid slows down and the propagation time is lengthened. The propagation time is calculated in the arithmetic unit 43 from the mutual electric signals thus output, and the flow rate is calculated from the difference in propagation time. The flow rate calculated in the arithmetic unit 43 is converted into an electric signal and output to the controller 44.

In the transmission unit 86, as described above, the directivity of the ultrasonic vibration into the measuring tube 82 is strengthened by the shape of a substantial cone on the one hand, and the use of a metal high in ultrasonic propagation characteristic suppresses the attenuation of the amplitude of the ultrasonic vibration on the other hand. Also, since the ultrasonic vibrator 90 itself is not in contact with but spaced from the measuring tube 82, the ultrasonic vibration transmitted along the tube wall which is one cause of the noise and other disturbances can be reduced, thereby making a highly accurate flow rate measurement possible. Further, the axial end surface 91 of the ultrasonic vibrator 90 is electrically on the earth side, and therefore, a highly accurate flow rate measurement is made possible with a reduced noise.

As understood from the foregoing description, the highly accurate flow rate measurement makes possible the highly accurate fluid control operation. Also, since the measuring tube 82 of the measuring instrument 81 according to the third embodiment is straight, the flow path of the fluid control path formed with the electric pinch valve 3 is substantially linear, so that the fluid control apparatus is substantially free of pressure loss. Especially in an application to a slurry transportation line, due to the absence of a point where the fluid stagnates, the stable flow rate measurement and the fluid control operation can be maintained with the slurry hardly fixed at each point of the flow path. Also, the linearity of the flow path can reduce the size of the measuring instrument 81, and the reduced space for the connecting portion between the measuring instrument 81 and the electric pinch valve 3 makes possible a more compact fluid control apparatus. Thus, the installation space of the fluid control apparatus can be further reduced.

Further, according to this embodiment, the measuring instrument 81 and the electric pinch valve 3 are integrally connected to each other, and therefore, the stress, if exerted on the connecting portion, can be received by the second coupling unit 96 and prevented from being imposed on the measuring instrument 81. Also, since the measuring instrument 81 and the electric pinch valve 3 can be disassembled in the second coupling unit 96, the maintenance the fluid control apparatus is facilitated, and the parts can be changed for each member. Further, in a configuration in which a measuring instrument for other measurements is connected to the second coupling unit 96, the simple replacement of the measuring instrument 2 can suitably meet the requirement of measuring all the fluids.

### Embodiment 4

Next, with reference to FIG. 1, an explanation is given about a case in which the fluid control pipe member according to the first embodiment is a tube pump. In the case where the fluid control pipe member shown in FIG. 1 is configured as a tube pump (not shown), the flow rate measured in the measuring instrument 2 is converted into an electrical signal, output to the arithmetic unit 43 in the control unit 4, and after calculation in the arithmetic unit 43, output to the controller 44. In the controller 44, the signal is output to the tube pump drive unit in such a manner as to reduce to zero the difference between an arbitrarily set flow rate and the flow rate measured in real time, and a roller is driven to rotate and move while pressing the tube. The fluid flowing out of the tube pump is controlled by the tube pump in such a manner that the set flow rate is achieved, i.e. the error between the set flow rate and the measured flow rate is converged to zero.

1. A fluid control apparatus comprising:
a measuring instrument for measuring the characteristics of the fluid flowing in the flow path, converting the measurement of the characteristics into an electrical signal and outputting the electrical signal;
a fluid control pipe member with a body in which a tube forming the flow path to control the fluid flow rate by changing the opening area of the tube is arranged; and
a control unit for controlling, by feedback, the adjustment of the opening degree of the fluid control pipe member based on the electrical signal from the measuring instrument;
wherein:
the fluid control pipe member includes:
a first coupling unit and a second coupling unit each having an insert portion fitted in the tube in watertight state at one end thereof, and a connection unit at the other end thereof and a flange at the intermediate portion thereof, and
a holding unit formed with a through-hole at the center thereof and a large-diameter portion fitted with a tube in the state fitted on the insert portion at one end of the through-hole;
the tube is arranged via the through-hole of the holding unit, and the assembly of the insert portion of the first and second coupling units fitted at the two ends of the tube is fitted on a large-diameter portion of the holding unit;
the flange of the second coupling unit and the holding unit are fixed in pressure contact between the fluid control pipe member and the measuring instrument; and
the connection unit of the second coupling unit is connected directly to the fluid inlet or the fluid outlet of the measuring instrument.

2. The fluid control apparatus as set forth in claim 1, wherein:
the fluid inlet or the fluid outlet of the measuring instrument has a fitting portion, and
the connection unit of the second coupling unit is directly connected by being fitted on the fitting portion of the measuring instrument in watertight state.

3. The fluid control apparatus as set forth in claim 1, wherein the fluid inlet or the fluid outlet of the measuring instrument is directly connected to the connection unit of the second coupling unit by thermal welding, ultrasonic fusion or bonding.

4. The fluid control apparatus as set forth in claim 1, wherein:
the fluid control pipe member is a pinch valve,
the body of the fluid control pipe member includes a straight groove for receiving the tube on the flow path axis and a fitting groove formed deeper than the straight groove on at least one end of the straight groove, and
the fluid control apparatus further comprising
a press element to change opening area of the tube by pressing or releasing the tube, and
a drive unit fixedly coupled on the upper part of the body of the fluid control pipe member to move the press element vertically; and
wherein at least the flange of the first coupling unit and the holding unit are fitted in the fitting groove in pressure contact.

5. The fluid control apparatus as set forth in claim 4, wherein:
the drive unit includes a motor unit arranged above the bonnet and a stem for vertically moving the press element by driving the motor unit, and
the press element is arranged under the stem.

6. The fluid control apparatus as set forth in claim 4, wherein:
the drive unit includes:
a cylinder body having a cylinder part therein and a cylinder cover integrated with the upper part thereof,
a piston able to slide up and down on the inner circumferential surface of the cylinder part in a sealing state and having a connecting part vertically protruded from the center so as to pass through a through-hole provided in the center of the bottom surface of the cylinder body in a sealing state, and
air ports provided at the circumferential side surface of the cylinder body, and communicating with a first space formed surrounded by the bottom surface and the inner circumferential surface of the cylinder part and the bottom end surface of the piston, and a second space formed surrounded by the bottom end surface of the cylinder cover and the top surface of the piston, and
wherein the press element is fixed at the bottom end of the connecting part.

7. The fluid control apparatus as set forth in claim 4, wherein:
the measuring instrument includes a sensor unit for measuring the characteristics of the fluid flowing through the flow path and an amplifier unit for calculating the fluid characteristics by receiving the electrical signal measured by the measuring instrument,
and at least the sensor unit and the fluid control pipe member are arranged in a single casing.

8. The fluid control apparatus as set forth in claim 7, wherein:
the measuring instrument includes at least one of the flowmeter, the pressure gauge, the thermometer, the densitometer and the current meter.

9. The fluid control apparatus as set forth in claim 8, wherein:
the measuring instrument is a flow rate measuring instrument including: a continuous arrangement of an inlet flow path communicating with a fluid inlet, a first rise flow path vertically arranged from the inlet flow path, a straight flow path communicating with the first rise flow path and formed substantially in parallel to the inlet flow path axis, a second rise flow path vertically arranged on the straight flow path and an outlet flow path communicating with the second rise flow path in the direction substantially in parallel to the inlet flow path axis and communicating also with the fluid outlet; a sensor unit having a pair of ultrasonic vibrators arranged in opposed relation to each other at the position of the side walls of the first and second rise flow paths crossing the axis of the straight flow path; and an amplifier unit connected to the ultrasonic vibrators through a cable; and
the ultrasonic vibrators are switched alternately between transmission and reception and the difference in the propagation time of the ultrasonic wave between the ultrasonic vibrators is measured thereby to calculate the flow rate of the fluid flowing through the straight flow path.

10. The fluid control apparatus as set forth in claim 8, wherein:
the measuring instrument is a flow rate measuring instrument configured of a tube having a straight flow path communicating with the fluid inlet and the fluid outlet and two ultrasonic transceivers mounted in spaced relation to each other on the outer circumferential surface of the tube along the axis thereof, wherein each of the ultrasonic transceivers includes: a cylindrical transmission unit fixed on the outer circumferential surface of the tube in such a manner as to surround the tube and an ultrasonic vibrator in the shape of a holed disk surrounding the tube and arranged in spaced relation to the outer circumferential surface of the tube,
the transmission unit includes a sensor unit having an axial end surface extending in the direction perpendicular to the axial direction of the tube, the ultrasonic vibrators each having the axial end surface fixed on the axial end surface of the transmission unit, and an amplifier unit connected to the ultrasonic vibrator through a cable, and
a voltage is applied between the axial end surfaces of each ultrasonic vibrator so that the ultrasonic vibrator is switched alternately between transmission and reception by expansion and contraction in axial direction, and the difference in the propagation time of the ultrasonic wave is measured between the ultrasonic vibrators thereby to calculate the flow rate of the fluid flowing along the straight flow path.

11. The fluid control apparatus as set forth in claim 1, wherein:
the fluid control pipe member is a tube pump.

12. The fluid control apparatus as set forth in claim 4, wherein:
the material of the tube is EPDM, fluoro rubber, silicone rubber or a composite material thereof.

13. The fluid control apparatus as set forth in claim 5, wherein:
the material of the tube is EPDM, fluoro rubber, silicone rubber or a composite material thereof.

14. The fluid control apparatus as set forth in claim 6, wherein the material of the tube is EPDM, fluoro rubber, silicone rubber or a composite material thereof.

15. The fluid control apparatus as set forth in claim 11, wherein the material of the tube is EPDM, fluoro rubber, silicone rubber or a composite material thereof.

16. The fluid control apparatus as set forth in claim 4, wherein the tube is formed of a composite material of polytetrafluoroethylene and silicone rubber.

17. The fluid control apparatus as set forth in claim 5, wherein the tube is formed of a composite material of polytetrafluoroethylene and silicone rubber.

18. The fluid control apparatus as set forth in claim 6, wherein the tube is formed of a composite material of polytetrafluoroethylene and silicone rubber.

19. The fluid control apparatus as set forth in claim 11, wherein the tube is formed of a composite material of polytetrafluoroethylene and silicone rubber.
